(19) United States
(12) Patent Application Publication
(10) Pub. No.: US 2008/0194432 A1
(43) Pub. Date: Aug. 14, 2008

(54) Method for breaking the viscosity of polymer-thickened aqueous systems for mineral oil and natural gas exploration

(76) Inventors: Jurgen Heidlas, Trostberg (DE); Allen Gossen, Kingswood, TX (US); Johann Plank, Trostberg (DE); Peter Lange, Obing (DE); Gregor Keilhofer, Tacherting (DE); Georg Huber, Traunreut (DE)

Correspondence Address: FULBRIGHT & JAWORSKI, LLP, 666 FIFTH AVE, NEW YORK, NY, 10103-3198, US

(21) Appl. No.: 11/706,058

(22) Filed: Feb. 14, 2007

(51) Int. Cl. C09K 3/00

(52) U.S. Cl. 507/219

(57) ABSTRACT

A novel method for breaking the viscosity of an aqueous phase thickened with preferably hydrophilic polymers in the exploration and production of mineral oil and/or natural gas is proposed. For this purpose, the breaking is carried out via the formation of a low-viscosity emulsion, with water as the continuous phase, this emulsion being formed by the addition of at least one surface-active component to a system which consists of the thickened drilling fluid and an oil phase which is crude oil present in the reservoir and/or oil introduced into the reservoir. Solubilizers between oil phase and water phase and in particular non-ionic surfactants, cationic surfactants and/or amphoteric surfactants are used as a preferred surface-active component. In addition to the surface-active component, it is possible to use further components, which are demulsifiers, non-emulsifiers, co-surfactants or surface tension modifiers. With the aid of this method, with the simultaneous presence of an oil phase, the aqueous phase can be displaced as a low-viscosity system and finally discharged at the surface, extremely effective cleaning of the well being associated therewith. With regard to the cost-efficiency and from an environmental point of view, the use of chemicals can be completely dispensed with.

### FIELD OF THE INVENTION

The present invention relates to a novel process for breaking the viscosity of an aqueous phase thickened with polymers in the exploration and production of mineral oil and/or natural gas.

### BACKGROUND AND SUMMARY OF THE INVENTION

The use of thickening polymers in the various well treatment and stimulation fluids is widespread in exploration operations of mineral oil and natural gas deposits. The importance of the polymers used in each case differs: firstly, they are used, for example, for producing a shear-thinning rheology in drilling fluids in order better to be able to remove drill cuttings or, as, for example, also in the case of the so-called fluid loss pills, to achieve filtrate control, which reduces the loss of the drilling fluid via the borehole wall. In the case of the so-called fracturing fluids the viscosity thereof prevents sand (“proppant”) which is introduced as part of the process into the opened cracks and fissures of the formation from settling out prematurely from the fluid. In addition, pressure for breaking open the formation can be more readily built up during fracturing and in particular during so-called hydraulic fracturing with thickened fluid. (“Composition and Properties of Drilling and Completion Fluids”, 5^{th} edition, Darley H. C. H. & Gray G. R., Gulf Professional Publishing, Houston, 1983 and “Oilfield Chemicals”, Fink J. K., Gulf Professional Publishing, Houston, 2003).

In virtually all exploration operations which are carried out with polymer-thickened aqueous, i.e. also “water-based” fluids, it is finally necessary to remove the fluid system from the well, it being extremely desirable for the viscosity thereof to be broken. There may be various reasons for this, such as, for example, recovery of the fluid by a easier method from the well and/or in order to avoid blockage of the formation pores, which subsequently adversely affects the productivity of the reservoir rock. This would benefit itself in particular by the borehole wall being less permeable to mineral oil and natural gas since the pores and channels of the rock are completely or partly blocked by the hydrated aqueous solution or the thickened biopolymer molecules accumulate on the reservoir rock and thus reduce the permeability thereof to the hydrocarbon, which has the same disadvantages.

Different methods are usually used for breaking the viscosity of aqueous systems thickened with polymers: firstly, the polymer chains can be degraded by oxidative cleavage or by thermolysis; secondly, it is possible to hydrolyse the polymer chains with the aid of chemical or enzymatic measures, strong mineral acids and hydrolase enzymes being used.

Alkali metal peroxides which serve as a peroxide source and initiate a free radical cleavage of the polymer chains are used for the oxidative degradation of the polymer chains. Variants in which the peroxides are present in encapsulated form and are added as so-called “internal breakers” to the thickened fluid system are known. It is also possible to carry out the cleavage with temperature induction or with the aid of acid activation and hence with a time lag (U.S. Pat. No. 6,861,394). In the thermolysis, the increased temperature of the reservoir is used for thermally degrading the polymer.

In a chemical hydrolysis, a strong mineral acid, such as hydrochloric acid, is generally pumped into the well. This acid component initiates the hydrolytic cleavage via the change in the pH and also with the aid of the increased temperatures prevailing in the subterranean formation. An enzymatic degradation of polymers, biopolymers and derivatives thereof is of course possible only when corresponding enzyme preparations are available. However, these are not always in practice. In addition, many enzyme systems are extremely sensitive and, for example, are denatured by relatively high temperatures and lose their catalytic activity thereby. Even in the presence of high ion concentrations, which are for example present in salt solutions and are used in completion operations, enzyme preparations are of little use.

A further crucial disadvantage of two above-described oxidative and hydrolytic processes for the degradation of the polymers is due to the fact that insoluble polymer fragments which are precipitated may also form (cf. “High Performance Fracture Fluid outperforms Conventional Fluids”; Palmore L. et al., World Oil, June 2003, pages 42 to 46). Although the viscosity can be broken thereby via the degradation of the polymers, the blockage of the formation pores by resulting fragments and hence the problem of formation damage as a whole are solved only in an unsatisfactory manner.

Most elegant in terms of process technology would be the possibility to break the viscosity of the thickened aqueous phase breaks on contact with the oil produced from the formation. To date, however, only so-called viscoelastic surfactant systems (VES) were capable of achieving this: On contact with oil the most “rod-shaped” or “wormlike” micelles are unstable and the viscosity-forming structural element is thus destroyed. Due to the significant practical importance of this behaviour, numerous publications and patents which are concerned with the use of VES in oilfield exploration were published. The following patents may be mentioned by way of example in this context: U.S. Pat. No. 4,965,389, US 2002/0033260, US 2003/0236174, U.S. Pat. No. 6,762,154, WO 98/56 497 A, U.S. Pat. No. 5,964,295 and U.S. Pat. No. 6,509,301.

Even the VES systems regarded as being particularly suitable have proved to be only partly useful for thickening of water-based exploration fluids and in particular brines and fracturing fluids. As a rule, a high surfactant concentration is in fact necessary for achieving sufficient thickening. In addition, the solutions thickened with VES generally have only very little thermal stability and the viscosity breaks because the surfactants separate from the aqueous phase. In addition, particularly for the so-called brines, very special surfactant formulations are required. This is the explanation that such formulations can also be used only for very special systems, i.e. depending on the salt used and in an extremely narrow range of the tolerated salt concentrations. In summary, it may be stated that many different products are necessary in order to meet the requirements in practice; this is also to be regarded as being negative from economic points of view.

In contrast, thickening polymers, in particular those of biological origin, have long proved useful in practice and they are therefore widely used as standard products for thickening aqueous systems in the exploration of mineral oil and natural gas. Biopolymers have a very broad spectrum of use and are extremely tolerant compared with the different compositions of water-based exploration fluids. Also on cost considerations viscosifying polymers are as a rule preferable to the VES. At present, thickening polymers are therefore used in many aqueous systems in well operations, such as, for example, in drilling fluids, but also in drill-in fluids, i.e. drilling fluids which are used for drilling into the hydrocarbon-containing formation. Another use is in fluid loss pills, which are highly thickened drilling fluids that are generally added only in relatively low parts by volume of the drilling fluid and in completion fluids (brine fluid loss pills). The use of thickening polymers is also possible in hydraulic fracturing fluids, in work-over fluids or in acidizing fluids.

In the present context, thickening “hydrophilic” polymers are understood as meaning all polymers of natural and non-natural origin, uncrosslinked or crosslinked, which are used for thickening aqueous phases. This also includes salt-containing systems (so-called brines), acids and more complex water-based drilling fluids for subterranean exploration which may additionally contain further functional additives.

The viscosity of the aqueous systems thickened with hydrophilic polymers cannot be broken by contact with oils, such as, in particular, crude oil. Rather, there is a risk that a stable and thick emulsion consisting of the water phase and the oil phase will form, which may cause severe problems being associated therewith in the completion of the well for the production of the hydrocarbon. Thus, the formation of a stable and thick emulsion in the oil-producing zone of the wellbore, the so-called “payzone”, may have a fatal effect on the productivity of the entire well.

In the present context, the term “oil” is understood as meaning a hydrophobic liquid which is not miscible with water and, as a pure substance, forms a two-phase system with water. According to this definition, oils include crude oils, diesel oil, mineral oils, ester oils, natural oils and fats in the form of triglycerides, saturated and unsaturated synthetic oils, internal olefins and α-olefins, but also polypropylene glycols and chemical derivatives thereof and mixtures of the various oil types.

On the basis of the prior art described and the associated disadvantages, it was the object of the present invention to provide an improved method for breaking the viscosity of an aqueous phase thickened with polymers in the exploration, stimulation, and/or production of mineral oil and/or natural gas. With regard to a reduction of the formation damage and an associated impairment of the subsequent amount of mineral oil and natural gas produced per time unit, it would be desirable to break the viscosity of aqueous systems which are thickened with hydrophilic polymers via the contact with oil. This novel method should be capable of being carried out in a technically simple manner and, inter alia, therefore also economically.

This object was achieved by a corresponding method in which the breaking is carried out by the formation of a low-viscosity emulsion, with water as the continuous phase. This emulsion is being formed by addition of at least one surface-active component a) to a system which consists of the phase thickened with a polymer component and an oil phase which comprises crude oil present in the reservoir and/or and oil introduced into the reservoir.

Surprisingly, it has been found that, by introducing surface-active compounds into aqueous systems which are thickened with in particular hydrophilic polymers, with the simultaneous presence of an oil phase, the viscosity of the aqueous systems can be broken via the formation of an emulsion, and the latter can be displaced as a low-viscosity system and finally discharged from the well formation. This procedure provides a novel possibility for extremely effective cleaning of a well. The method can be used in the exploration of both mineral oil and natural gas, in the latter case the required oil phase being introduced into the well from the outside. In addition, the use of the chemicals used to date, which are extremely difficult to handle, such as, for example, peroxides or sensitive enzyme systems, can be rendered completely superfluous.

Moreover, it has been found that the characteristic rheology profile of the polymers thickening the water phase is retained by the addition of the surface-active component according to the invention. The rheology of the thickened water phase therefore remains substantially unchanged and corresponds to the state before the addition of the surface-active component. Furthermore, the rheology changes only insignificantly as a result of the addition of suitable oils in amounts which are below the limiting concentrations and the subsequent formation of an o/w emulsion. In some cases, the emulsions obtained can even improve the rheology, a higher viscosity occurring in particular at low shear rates, which is of particular importance in the case of drilling fluids for suspending the drill cuttings.

### DETAILED DESCRIPTION

The invention preferably envisages that the surface-active component a) is added either to the thickened aqueous drilling fluid or to the oil phase. The addition of the component a) to both phases is also possible.

In the procedure according to the invention, o/w emulsions are first formed, from which more complex, mixed emulsion systems, such as, for example, of the w/o/w type, then form on breaking of the viscosity. Common to all of these is that the thickening polymers are surrounded by an oil phase or at least the hydrophilic polymers interact with the oil so that interaction of the polymers in the emulsion which leads to thickening is weakened. The result is an emulsion which is greatly reduced in viscosity and which has lost the typical rheology profile of the thickening polymer, which is understood as meaning, for example in the case of biopolymers, a high carrying power or high viscosity at low shear rates.

If it is intended to break the viscosity of polymer-thickened aqueous systems with crude oil in the reservoir or ground formation, the present invention provides a preferred process variant which makes it possible to carry out the method also with more viscous crude oils (“heavy crude oils”): as described above, the addition of a suitable oil to the thickened aqueous phase which contains the surface-active component a) results in the formation of an o/w emulsion; hereby, the added concentration of oil should be below the so-called threshold concentration at which the formation of the mixed emulsions which in the end would break the viscosity occurs. If this stable o/w emulsion is brought into contact with a crude oil in the ground formation, only small amounts of crude oil are necessary in order to exceed the limiting concentration at which the mixed emulsions, such as those of the w/o/w type, occur and finally break the viscosity of the aqueous solution. By this it is possible to circumvent the problem that high-viscosity emulsions form with the viscous crude oil and the thickened aqueous phase, in which emulsions the desired emulsion types can form only with difficulty and slowly.

As a rule, only moderate shear rates are required for the preparation of the emulsions described which finally lead to breaking of the viscosity of the aqueous phase thickened with polymers on exceeding the threshold concentration of oil, since the formation thereof can be greatly facilitated by the addition of the surface-active system according to the invention. In practice, during pumping of the oil intended for breaking into the well, adequate flow conditions are present for the formation of the emulsions and for breaking the viscosity of the thickening polymers in the region of the borehole wall. Moreover, the flow of the crude oil in the so-called payzone is normally sufficiently strong enough to achieve sufficient mixing of the crude oil with the thickened water phase. As a result, produced crude oils having low viscosity (“light” crudes) therefore break the thickened polymer solutions generally by themselves and can be washed in low-viscosity emulsions out of the subterranean formation. In this way, an improvement of the oil flow through the oil-bearing ground formation can be achieved in a very simple manner in terms of process engineering since the risk to the formation by blockage of the formation pores by thickened aqueous phases can be avoided. Finally, the productivity of the mineral oil drilling is improved, which in economic terms can be calculated over the entire lifetime of the particular wall of the borehole location.

For thickening aqueous systems it is possible to use hydrophilic polymers (according to definition) of a very wide range of chemical compositions. Such polymers may be of both natural and synthetic origin. Among the number of natural polymers which may also be derivatized synthetically xanthan gum, welan gum, diutan, cellulose derivatives, such as, for example, carboxymethylcellulose (PAC, CMC) or hydroxyethylcellulose (HEC), guar gum and derivatives thereof, such as carboxymethyl (CMG)-, or carboxyethylhydroxypropylguar (CMHPG), hydroxypropylguar (HPG), starch and scleroglucans and suitable derivatives thereof are preferred. Among the number of synthetic polymers acrylic acid copolymers and acrylic acid terpolymers and co- and terpolymers having AMPS building blocks and especially the newer particularly thermally stable polymers according to U.S. Pat. No. 6,579,947 are particularly suitable.

The present invention envisages at least one member of the series consisting of diesel oil, mineral oil, ester oil, vegetable oil (triglycerides), saturated and unsaturated synthetic oil, such as n-paraffins, internal olefin or α-olefin or polypropylene glycol as oil component to be introduced into the ground formation. Chemical modifications and mixtures thereof may also be suitable as well and all variants should particularly be present with low viscosity which in particular is the case at method temperatures.

In the desired emulsion which is required according to the invention for breaking the viscosity, a certain amount of oil, the so-called threshold concentration, must be exceeded between the oil phase and the drilling fluid thickened with polymers in order to initiate the breaking of the viscosity. Typically, about 1 to 2 parts by volume of oil per 5 parts by volume of the thickened aqueous system are sufficient in the emulsion. This ratio can, however, vary within wide ranges and greatly depends from the composition of the aqueous phase, the thickening polymer used and the oil. As already described there is a specific limiting concentration of oil for each system. If this is not exceeded, the characteristic rheology profile of the thickening polymer in the o/w emulsion is substantially retained. For the purposes of the present invention this property can be used to carry out the method according to the invention as well with relatively high-viscosity crude oils in mineral oil exploration.

Suitable standard oils to be introduced must fulfill certain preconditions. They should show a viscosity as low as possible and of course they must not adversely affect the viscosity of the thickened drilling fluid. They have to optionally also fulfill general conditions regarding environmental protection and they should be biodegradable. In particular, vegetable oils, such as, for example, palm oil, rapeseed oil, soya oil and maize oil, and derivatives thereof, such as, for example, esters, fulfill these conditions.

Regarding component a), it is also comprised that the surface-active component is a solubilizer between oil phase and water phase and in particular is a non-ionic surfactant, cationic surfactant and/or amphoteric surfactant; these might contribute to the formation of the emulsion required for the invention. Suitable members of the non-ionic surfactants are in particular ethoxylated long chained and/or branched alcohols, ethoxylated carboxylic acids and ethoxylated nonylphenols having 2 to 11 EO units and in particular NP-4-EO or NP-6-EO, ethoxylated long chained and branched alcohols, ethoxylated carboxylic acid and ethoxylated esters of glycerol. From the number of alcohols C₉-C₁₄-alcohols having 2 to 8 EO units and particularly preferably ethoxylated tridecanols having 2 to 4 EO units are especially suitable. However, carboxylic acids having 9 to 14 carbon atoms and 2 to 8 EO units are also suitable. Members of the series of ethoxylated amines, C₈-C₁₈-alkanolamides or imidazoline derivatives and here in particular amines with 8 to 16 carbon atoms and 2 to 8 EO units and cocodiethanolaminoamide are typical cationic surfactants and betaines and in particular amidopropyl betaines with 8 to 14 carbon atoms are regarded as amphoteric surfactants.

In special cases, the sole use of said surface-active components as emulsifiers may not be sufficient for breaking the viscosity of the thickened aqueous systems. It is in fact also possible to form high-viscosity emulsions which moreover may be very stable. In these cases it has proved to be advantageous if a component b) is used additionally to the component a).

This component b) preferably originates from the group consisting of the demulsifiers, non-emulsifiers, co-surfactants or surface tension modifiers, all of which preferably prevent the formation of a stable high-viscosity emulsion.

For the purposes of the present invention, 2-ethylhexanol or imidazoline quats and here in particular methyl-1-tallow amidoethyl-2-tallow-imidazolinium methosulphate or demulsifying polymers and in particular co- and terpolymers of the methacrylic acid type or (partly) ethoxylated abietylamines and in particular a 90% hydroabiethylamine or polyether-modified polysiloxanes have proved to be typical members of the demulsifiers or non-emulsifiers group. These compounds are effective as surface-active substances directly at the phase boundaries and can thus contribute to the breaking of the micelles and simultaneously destabilize the emulsion (demulsifier) or prevent the formation of stable micelles and hence the formation of a stable emulsion (non-emulsifier). Especially the polyether-modified polysiloxanes have proved to be helpful since they can be used in low concentrations. Examples of this class of compounds are Tegopren 5802 and TEGO Antifoam MR 475 from Goldschmidt GmbH, Essen. They constitute a typical antifoaming agent with a demulsifying effect. In this context it should be taken into account that, on the one hand, the aqueous systems thickened with hydrophilic polymers are to be rendered miscible with the oil phase via the addition of an emulsifier. On the other hand, demulsifiers or non-emulsifiers are added which normally make it more difficult to form the desired emulsion. This ostensible contradiction can be eliminated when the surface-active components a) acting as an emulsifier are used in excess or the surface tension modifiers are used. Silicone derivatives and/or polymers having (per)fluorinated carbon side chains and in particular silicone oils, such as, for example, dimethylpolysiloxanes or α,ω-difunctional silicone quats are particularly suitable members of such modifiers.

The use of demulsifiers or non-emulsifiers may be necessary in particular when polymer gels in highly concentrated salt solutions are to be broken. This is important when so-called fluid loss pills are applied in completion operations. As a rule, these classes of substances are used when the breaking of the viscosity in the aqueous systems thickened with polymers is to be achieved by the flow of crude oil into the ground formation.

Regarding the surface tension modifiers which are preferably used as component b), it should be noted that especially dimethylpolysiloxane but also perfluorinated hydrocarbons form extremely large contact angles at the phase boundary with water. Among the number of silicone oils, dimethylpolysiloxanes (DMPS) are also especially suitable since they are miscible with most oils and then increase the surface tension between the oil phase and the water phase. The abovementioned difunctional silicone quats, which are known under the trade names Tegopren 6921 to 6924 (from Goldschmidt GmbH), are effective even in low concentrations since they are capable of accumulating selectively at the phase boundaries, which makes them appear more suitable compared with unfunctionalized simple silicone oils. In addition, these silicone derivatives can be integrated more easily than silicone oils together with the emulsifiers in homogeneous and one-phase formulations.

In general, it should be noted that the formation of an emulsion can be additionally facilitated by the use of surface tension modifiers, since substantially less shear energy has to be applied for the formation of the emulsions required for the invention.

The so-called co-surfactants, which are preferably hydrophilic compounds and in particular those of the alkylpolyglucoside (APG) type and particularly preferably those having 6 to 12 carbon atoms, are also suitable as component b). These co-surfactants are characterized in that they cannot by themselves contribute to the desired emulsifying effect for the formation of the emulsion. However, they support the action of the emulsifiers in the manner desired according to the invention.

From a preferred point of view, the systems according to the invention and consisting of emulsifiers (component a)) and demulsifiers/non-emulsifiers and/or surface tension modifiers and/or co-surfactants can be added both to the aqueous systems and to the oil phase. The latter is feasible in terms of process engineering only when the oil for breaking the viscosity is pumped into the well and the thickened aqueous system is to be displaced. If the surfactant system required in association with the present invention is added to the aqueous phase, i.e. for example to the drilling fluid or the fracturing fluid, this is preferably effected after the aqueous phase was thickened with the polymer with the use of relatively high shear rates. The use of moderate shear rates is on the other hand sufficient for distributing the surfactant system homogeneously in the thickened aqueous phase. Possible foam formations can therefore reliably be avoided during the preparation of the drilling fluid.

Suitable concentrations for the surfactant system used according to the invention in the aqueous phase and/or the oil phase can generally vary within wide ranges. They depend mainly on the compounds used in the formulation, the type and concentration of the thickening polymers, the composition of the aqueous phase and on the oil phase or the oil mixtures which are to be used for the formation of the emulsion. Preferably, the components a) and optionally b) should in each case be used in amounts between 0.05 and 5.0% by weight and preferably between 0.1 and 1.5% by weight, based in each case on the amount of the water phase and/or of the oil phase.

As already discussed repeatedly, a preferred aspect of the present invention is that an o/w emulsion results, which should preferably take place at the time of breaking of the viscosity in the form of mixed emulsion systems. O/w emulsions are oil-in-water emulsions, the aqueous medium representing the external (continuous) phase in which the oil droplets are dispersed. The w/o/w emulsions regarded as being particularly advantageous in the present context are mixed emulsion systems which are also referred to as double emulsions. In these cases, a further water phase is enclosed in the oil droplets emulsified in the water phase.

The present invention also envisages that the components a) and optionally b) are used as a preformulation. This should occur in particular as a suspension in combination with a polymer component which is suitable for thickening the water phase. In practice, the respective components are therefore formulated as a product which is added either to the aqueous phase thickened with polymers and/or to the oil which is pumped from the surface into the borehole for breaking the viscosity. The respective components can, however, also be distributed separately over the water phase and the oil phase or can be added to both phases, which has already been referred to in detail. The present invention pays particular attention to a preferred embodiment in which the respective system consisting of component a) and optionally b) is added to the thickened water phase, for example in the form of fracturing fluids, drill-in fluids, acidizing fluids or completion brines. The addition to so-called fluid loss pills in completion operations is also possible if an operation is to be carried out in the mineral oil-carrying formation layer, the so-called payzone. In general, a special use form is of particular importance to the method according to the invention, in which form it is used in the region of oil-carrying ground layers.

Especially in this context, so-called one-container products which have particular advantages for the user from practical points of view have proved to be particularly advantageous. Thus, for example, a polymer suitable for thickening the water phase can be dispersed in the form of a dried polymer powder in a liquid mixture of the surface-active component a) and optionally together with a standard oil. The user then uses a liquid or pasty one-container product which contains all components that are required for thickening the aqueous phase and for subsequent breaking of the viscosity with oil. In this case, too, an amount of a defined oil of a concentration such that the initial viscosity of the aqueous phase thickened with polymers is substantially retained and is stable is added to the thickened water phase in addition to the surfactant system according to the invention for the formation of the emulsion and an o/w emulsion is thus formed. Only when a certain limiting concentration of oil is exceeded in the thickened water phase the viscosity does break because the oil phase interferes with the viscosity-forming interaction of the polymers. This then takes place subterraneously in the formation via the flow of crude oil into the thickened drilling fluid which already contains the amount of the defined oil quality below the limiting concentration.

The following examples describe the advantages of the described method according to the invention.

### EXAMPLES OF PREFERRED EMBODIMENTS

### Example 1

Breaking the viscosity of a fresh water drilling fluid thickened with scleroglucan (trade name: Biovis from BASF Construction Polymers GmbH) and xanthan gum (trade name: Bioflow from BASF Construction Polymers GmbH)

### Description of the Composition

emulsifier: cocodiethanolaminoamide (trade name: Rewomid DC 212 from Goldschmidt GmbH)

demulsifier: 2-ethylhexanol

oil for breaking: diesel

Remark: 100 ml of diesel are required for breaking the viscosity of 350 ml of polymer gel.

### Description of Experiment (Explanation of the Table):

350 ml of tap water+x g of 2-ethylhexanol

3.5 g of Biovis (I) or Bioflow (II) added with stirring, stirred for 20 minutes under HBM and cooled to room temperature

measured on the Brookfield at 0.5 rpm and 100 rpm (A)

3 g of Rewomid DC 212 S added and stirred in for 3 minutes with IKA stirrer measured on the Brookfield at 0.5 rpm and 100 rpm (B)

heated to 60° C. with the heating cup

measured on the Brookfield at 0.5 rpm and 100 rpm (C)

500 ml of diesel oil added dropwise in the course of 5 minutes and stirred in for a further 3 minutes

measured on the Brookfield at 0.5 rpm and 100 rpm (D)

a further 50 ml of diesel oil added dropwise in the course of 5 minutes and stirred in for 3 minutes

measured on the Brookfield at 0.5 rpm and 100 rpm (E)

Brookfield viscosity

| 2-ethylhexanol | | 0.5 rpm | 100 rpm |
|---|---|---|---|
| in g | | in mPa · s | in mPa · s |
| 0.0 | A: after mixing | 24 000 | 324 |
| (1 ml of TBP) | B: + DC 212 S | 25 600 | 312 |
| | C: at 60° C. | 28 800 | 296 |
| | D: +50 ml of diesel | 25 600 | 232 |
| | E: +50 ml of diesel | 10 400 | 208 |
| 1.0 (I) | A: after mixing | 32 000 | 320 |
| | B: + DC 212 S | 30 400 | 328 |
| | C: at 60° C. | 22 400 | 320 |
| | D: +50 ml of diesel | 25 600 | 320 |
| | E: +50 ml of diesel | 800 | 152 |
| 1.0 (II) | A: after mixing | 65 600 | 576 |
| | B: + DC 212 S | 84 800 | 880 |
| | C: at 60° C. | 92 000 | 840 |
| | D: +50 ml of diesel | 18 000 | 510 |
| | E: +50 ml of diesel | 2000 | 116 |

### Example 2

Breaking of the viscosity of a CaCl₂ solution thickened with scleroglucan (trade name Biovis) and having a density of 10.5 ppg (1.26 g/ml)

### Description of the Composition

emulsifier: cocodiethanolaminoamide (trade name: Rewomid DC 212)

demulsifier: 2-ethylhexanol

oil for breaking: diesel

Remark: 100 ml of diesel are required for breaking the viscosity of 350 ml of polymer gel. Without 2-ethylhexanol, viscosity cannot be broken.

### Description of Experiment (Explanation of the Table):

318 ml of tap water

123.5 g of CaCl₂ added with cooling

x g of 2-ethylhexanol

3.5 g of Biovis added with stirring

stirred for 20 minutes under HBM and then cooled to room temperature

measured on the Brookfield at 0.5 rpm and 100 rpm (A)

3 g of Rewomid DC 212 S added and stirred in for 3 minutes with IKA stirrer

measured on the Brookfield at 0.5 rpm and 100 rpm (B)

heated to 60° C. (heating cup)

measured on the Brookfield at 0.5 rpm and 100 rpm (C)

50 ml or 25 ml or 10 ml of diesel oil added dropwise in the course of 5 minutes and stirred in for 3 minutes

measured on the Brookfield at 0.5 rpm and 100 rpm (D)

a further 50 ml of diesel oil added dropwise in the course of 5 minutes and stirred in for 3 minutes

measured on the Brookfield at 0.5 rpm and 100 rpm (E)

stirrer speeds constantly adapted for obtaining thorough mixing

| | | Brookfield viscosity | |
|---|---|---|---|
| 2-ethylhexanol | | 0.5 rpm | 100 rpm |
| in g | | in mPa · s | in mPa · s |
| 0.0 | A: after mixing | 65 000 | 704 |
| | B: + DC 212 S | 52 800 | 736 |
| | C: at 60° C. | 56 000 | 704 |
| | D: +50 ml of diesel | 40 800 | 560 |
| | E: +50 ml of diesel | 33 600 | 536 |
| 1.0 | A: after mixing | 59 200 | 592 |
| | B: + DC 212 S | 56 000 | 608 |
| | C: at 60° C. | 56 000 | 592 |
| | D: +50 ml for diesel | 28 000 | 488 |
| | E: +50 ml for diesel | 5600 | 288 |
| 1.0 | A: after mixing | 56 000 | 560 |
| (repetition) | B: + DC 212 S | 56 800 | 612 |
| | C: at 60° C. | 59 200 | 584 |
| | D: +50 ml of diesel | 28 000 | 432 |
| | E: +50 ml of diesel | 7200 | 352 |
| 1.0 | A: after mixing | 50 400 | 512 |
| (only 10 ml of diesel | B: + DC 212 S | 51 200 | 576 |
| oil) | C: at 60° C. | 52 000 | 544 |
| | D: +10 ml of diesel | 53 600 | 520 |
| 1.0 | A: after mixing | 53 600 | 528 |
| (only 25 ml of diesel | B: + DC 212 S | 53 600 | 580 |
| oil) | C: at 60° C. | 53 600 | 532 |
| | D: +25 ml of diesel | 56 800 | 528 |

### Example 3

Breaking of the viscosity of a drill-in fluid which contains scleroglucan, xanthan gum, modified starch and calcium carbonate having a defined particle size (“seized carbonate”) with diesel oil; density of the drill-in fluid: 9.3 ppg (1.10 g/ml).

### Description of the Composition

emulsifiers: cocodiethanolaminoamide (trade name: Rewomid DC 212) or combination of Rewomid DC 212 and ethoxylated cocoamine having 5 EO (trade name: Varonic K-205 from Goldschmidt GmbH)

demulsifier: 2-ethylhexanol

oil for breaking: diesel

Remark: 100 ml of diesel are required for breaking the viscosity of 350 ml of polymer gel.

### Description of Experiment (Explanation of the Table):

In each case 350 ml of the drill-in fluid were characterized rheologically using an FANN 35A rotational viscometer after 50 ml of diesel oil were added in each case stepwise and stirred at speed 10 on the magnetic stirrer for 5 minutes.

Finally, the emulsion formed was mixed at relatively high shear rate on a Hamilton Beach Mixer.

Sample 1: blank value—no addition (drill-in fluid without addition of emulsifier)

Sample 2: addition of 2.0 g of Rewomid DC 212, 1.0 g of Varonic K-205 and

0.5 g 2-ethylhexanol to the drill-in fluid

Sample 3: addition of 2.5 g of Rewomid DC 212 and 1.0 g of 2-ethylhexanol to the drill-in fluid

FANN 35SA readings at 600-300-200-100-6-3 rpm

| Measurement of the | Blank value | | |
|---|---|---|---|
| rheology | (Sample 1) | Sample 2 | Sample 3 |
| before oil addition; | 89-65-54-39-12-9 | 88-64-53-38-13-9 | 93-70-58-43-17-14 |
| measured at 30° C. | | | |
| before oil addition; | 63-47-39-28-9-7 | 70-51-42-30-10-8 | 67-48-40-29-9-7 |
| measured at 60° C. | | | |
| after addition of 50 ml | 73-53-44-33-10-7 | 56-39-30-19-4-2 | 72-49-40-28-8-6 |
| of diesel oil at | | | |
| 60° C. - stirred for 5 min, | | | |
| measured at | | | |
| 60° C. | | | |
| after addition of a | 86-60-50-37-12-9 | 43-28-20-12-2-1 | 57-35-22-10-1-1 |
| further 50 ml of | | | |
| diesel at 60° C. (100 ml | | | |
| altogether) - | | | |
| stirred for 5 min | | | |
| measured at 60° C. | | | |
| after addition of a | 115-77-60-41-14-10 | 27-16-11-6-1-1 | 34-20-15-10-1-1 |
| further 50 ml of | | | |
| diesel at 60° C. (200 ml | | | |
| altogether) - | | | |
| stirred for 5 min | | | |
| measured at 60° C. | | | |
| emulsion of the last | 122-88-71-53-17-13 | 66-50-42-29-7-5 | 46-28-19-12-1-1 |
| step: | | Remark: stable | |
| HBM for 10 min, LS | | foam! | |
| for 5 min | | | |
| measured at 30° C. | | | |

### Example 4

Breaking of the viscosity of saturated completion or fracturing fluid thickened with hydroxyethylcellulose (HEC) or hydroxypropylguar (HPG) by means of crude oil.

### Description of the Composition

### Experiment A

saturated CaCl₂ brine (density: 11.6 ppg, 1.39 g/ml)

emulsifiers: combination of ethoxylated nonylphenol having 4 EO (trade name: Tergitol NP-4 from Dow) and cocodiethanolaminoamide (trade name: Rewomid DC 212)

non-emulsifier: methyl-1-tallow amidoethyl-2-tallow imidazolinium methosulphate (trade name: Accosoft 808 from Stepan)

oil for breaking: crude oil from the Gulf of Mexico

polymer: hydroxypropylguar (HPG)

### Description of Experiment

4 g of HPG (Ecopal 120 from Economy Polymers) were added to 350 ml of CaCl₂ brine (density 11.6 ppg, 1.39 g/ml) and thoroughly stirred at about 50° C. for 45 min on a magnetic stirrer. The resulting gel was so thick that no measurement with the FANN 35 could be carried out (reading>300). 1.8 g of Tergitol NP-4, 1.4 g of Accosoft 808 and 1.0 g of Rewomid DC 212 were added to the thickened gel and distributed in the gel with stirring at 50° C. Thereafter, 100 ml of crude oil were added to the gel in a beaker at 50° C. and slowly further stirred. The oil dissolved slowly in the polymer gel and spontaneous breaking of the rheology was detectable after about 10 min, a vortex having been formed by the magnetic stirring rod in the beaker. The measurement in the FANN 35 SA showed readings of less than 3 at 3 and 6 rpm.

### Experiment B

saturated CaBr₂ brine (density: 14.2 ppg, 1.70 g/ml)

emulsifier: ethoxylated nonylphenol having 4 EO and 6 EO (trade names: Tergitol NP-4 and NP-6 from Dow)

non-emulsifier: methyl-1-tallow amidoethyl-2-tallow-imidazolinium methosulphate (trade name: Accosoft 808)

oil for breaking: crude oil from the Gulf of Mexico

polymer: hydroxyethylcellulose (HEC)

### Description of Experiment

5 g of HEC (HEC 10 from Dow Chemical) were added to 350 ml of CaBr₂ brine (density 14.2 ppg, 1.70 g/ml) and thoroughly stirred at about 50° C. for 45 min on a magnetic stirrer. The resulting gel was so thick that no measurement with the FANN 35 SA could be carried out (reading>300). 1.7 g of Tergitol NP-4, 1.4 g of Accosoft 808 and 1.0 g of Tergitol NP-6 were added to the thickened gel and distributed in the gel with stirring at 50° C. Thereafter, 100 ml of crude oil were added to the gel in a beaker at 50° C. and slowly further stirred. The oil dissolved slowly in the polymer gel and spontaneous breaking of the rheology was detectable after about 10 min, a vortex having been formed by the magnetic stirring rod in the beaker. The measurement in the FANN 35 SA showed readings of less than 3 at 3 and 6 rpm.

### Example 5

Breaking of the viscosity of scleroglucan in a CaBr₂ solution (density: 9.7 ppg, 1.17 g/ml) using low shear energy with diesel oil

### Description of the Composition

CaBr₂ brine (density: 9.7 ppg, 1.17 g/ml)

emulsifiers: combination of ethoxylated nonylphenol having 4 EO (trade name: Tergitol NP-4) and cocodiethanolaminoamide (trade name: Rewomid DC 212)

surface tension modifier: α-,ω-difunctional silicone quat (trade name: Tegopren 6922 from Goldschmidt GmbH)

oil for breaking: diesel oil

polymer: scleroglucan

### Description of Experiment

3.5 g of scleroglucan were added to 350 ml of CaBr₂ bring (density: 9.75 ppg, 1.17 g/ml) and thickening was effected at low speed at room temperature over a period of 20 min on a Hamilton Beach Mixer. Thereafter, 2.8 g of Rewomid DC 212, 1.3 g of Tergitol NP-4 and 0.1 g of Tegopren 6922 were added to the thickened gel and homogenized in the gel for 5 min on a magnetic stirrer and in a beaker.

100 ml of diesel oil were added to the beaker with the polymer gel and the formulation thus obtained (heated to about 50° C.). In contrast to the preceding experiment, the diesel oil was distributed in the gel merely by swirling the beaker. After swirling for 3 minutes the rheology of the scleroglucan broke and a low-viscosity emulsion formed. The measurement in the FANN 35 SA showed readings of less than 3 at 3 and 6 rpm.

In an analogous experiment in which, however, the Tegopren 6922 was not added, no breaking of the viscosity was observable.

### Example 6

Breaking of the viscosity of scleroglucan in a CaCl₂ solution (10.5 ppg, 1.26 g/ml) with diesel oil, the formulation according to the invention having been added partly or completely to the diesel oil.

### Description of the Composition

CaCl₂ brine (density: 10.5 ppg, 1.26 g/ml)

emulsifiers: cocodiethanolaminoamide (trade name: Rewomid DC 212)

surface tension modifier: α,ω-difunctional silicone quat (trade name: Tegopren 6924)

oil for breaking: diesel oil

polymer: scleroglucan

### Description of Experiment

### Experiment A

3.5 g of scleroglucan were added to 350 ml of CaCl₂ brine (density: 10.5 ppg, 1.26 g/ml) and thickening was effected at low speed at room temperature for a period of 20 min on a Hamilton Beach Mixer. Thereafter, 3.3 g of Rewomid DC 212 were added to the thickened gel and homogenized in the gel for 5 min on a magnetic stirrer in a beaker.

100 ml of diesel to which 0.2 g of Tegopren 6924 had been added beforehand were added to the beaker with the polymer gel heated to above 50° C. and the Rewomid DC 212. The diesel oil could be readily distributed in the gel simply by swirling the beaker, and the rheology of the scleroglucan broke after 3 minutes: a low-viscosity emulsion formed. The measurement in the FANN 35 SA showed readings of less than 3 at 3 and 6 rpm.

### Experiment B

Experiment B was carried out analogously to experiment A, in this case both 3.5 g of Rewomid DC 212 and the Tegopren 6924 being added to the diesel oil. The result was comparable with that from experiment A. A low-viscosity emulsion in which the rheology of the scleroglucan had been broken could be formed simply by swirling.

### Example 7

Breaking of the viscosity of synthetic acrylic acid/acrylamide copolymer (PHPA) with diesel oil

### Description of the Composition

emulsifiers: combination of ethoxylated nonylphenol having 4 EO (trade name: Tergitol NP-4 from Dow) and cocodiethanolaminoamide (trade name: Rewomid DC 212)

surface tension modifier: α,ω-difunctional silicone quat (trade name: Tegopren 6922

oil for breaking: diesel oil

polymer: PHPA (trade name: Praestol 2350 from Degussa GmbH)

### Description of Experiment

0.5 g of Praestol 2350 was added to 350 ml of tap water and thickening was effected over a period of 40 min by stirring on a magnetic stirrer (speed 5 or 10) to give a clear gel. Thereafter, 2.8 g of Rewomid DC 212, 1.3 g of Tergitol NP-4 and 0.1 g of Tegopren 6922 were added to the thickened gel and homogenized in the gel for 5 min on a magnetic stirrer in a beaker; the gel became turbid but the rheology was retained.

100 ml of diesel were added to the beaker with the polymer gel and the formulation (heated to about 50° C.) and stirred further on the magnetic stirrer at speed 5. The gel-like consistency disappeared after the diesel oil had been emulsified. After about 15 min, a low-viscosity emulsion formed. The measurement in the FANN 35 SA rotational viscometer showed readings of less than 3 at 3 and 6 rpm.

### Example 8

Breaking of the viscosity of xanthan gum-thickened salt solutions (3% of NaCl and 10.0 ppg of CaCl₂) with n-paraffin oil (C11-C16): use of a “one-container product” (xanthan gum dispersed in the surfactant system according to the invention)

### Description of the Composition

emulsifier: cocodiethanolaminoamide (trade name: Rewomid DC 212)

demulsifier: 2-ethylhexanol

cosurfactant: C8-C10 alkylpolyglucoside (trade name: Glucopon 215 CSUP from Cognis)

oil for breaking: n-paraffin, C11-C16 (trade name: BioBase 560 from Shrieve)

polymer: xanthan gum (trade name: Bioflow from BASF Construction Polymers GmbH)

### Preparation of the “One-Container Product”:

25 g of Bioflow (xanthan gum) were added to a homogeneous mixture of 19 g of cocodiethanolaminoamide (Rewomid DC 212), 9.5 g of 2-ethylhexanol and 6.5 g of C8-C10 alkylpolyglucoside (Glucopon 215 CSUP) and stirred for 3 h. The consistency of the resulting product was pasty.

### Description of Experiment

In each case 6 g of the one-container product obtained were added to 350 ml of the salt solution with 3% of NaCl or 10 ppm of CaCl₂ and mixed at low speed for 15 min on the HBM until the solution had thickened without further increasing the viscosity. Thereafter, the viscosity of the solutions was measured at room temperature (RT) and at 120° F. (about 55° C.) using a FANN 35SA rotational viscometer. The addition of the oil for breaking the viscosity was effected on the magnetic stirrer at about 120° F., the oil having been mixed in by stirring for about 3 min. The procedure for the viscosity measurement is described in the column “Description” of the following tables:

A) 3% NaCl solution

| | | FANN Readings | | |
|---|---|---|---|---|
| Test No. | Description | 600-300-200-100-6-3 | PV | YP |
| 1 | Measurement at RT | 52-43-40-34-19-17 | 9 | 34 |
| 2 | Measurement at 120 F | 48-39-36-31-17-15 | 9 | 30 |
| 3 | Addition of 50 ml of | 57-39-32-23-6-4 | 18 | 21 |
| | BB 560 | | | |
| | addition at 120 F | | | |
| 4 | Addition of further 50 ml | 36-22-17-12-2-1 | 14 | 8 |
| | (100 ml altogether) | | | |
| | of BB 560 | | | |
| | addition at 120 F | | | |

PV: plastic viscosity [cP]
YP: yield point [lb/100 ft²]

B) 10 ppg CaCl2 solution

| | | FANN Readings | | |
|---|---|---|---|---|
| Test No. | Description | 600-300-200-100-6-3 | PV | YP |
| 5 | Measurement at RT | 54-42-37-28-12-10 | 12 | 30 |
| 6 | Measurement at 120 F | 46-37-32-25-10-8 | 9 | 28 |
| 7 | Addition of 50 ml of | 41-33-28-21-7-5 | 8 | 25 |
| | BB 560 | | | |
| | addition at 120 F | | | |
| 8 | Addition of further 50 ml | 30-18-14-9-1-1 | 12 | 6 |
| | (100 ml altogether) | | | |
| | of BB 560 | | | |
| | addition at 120 F | | | |

The two tables show that the viscosity of the xanthan gum had been broken on addition of 100 ml of Biobase (BB)) 560: the high low-end readings typical for xanthan gum at 6 and 3 rpm have significantly decreased.

### Example 9

Breaking the viscosity of xanthan gum-thickened salt solutions (9.5 ppg of NaCl and 10.0 ppg of CaCl₂) with crude oil, rapeseed oil having been added for standardizing the polymer solution.

Description of the Composition:

emulsifier: cocodiethanolaminoamide (trade name: Rewomid DC 212)

demulsifier/non-emulsifier methyl-1-tallow amidoethyl-2-tallow-imidazolinium methosulphate (trade name: Accosoft 808)

oil for breaking: crude oil from the Gulf of Mexico

oil for standardization: rapeseed oil or maize oil

polymer: xanthan gum (trade name: Bioflow)

### Description of Experiment

In each case 2.5 g of Bioflow were added to 350 ml of NaCl or CaCl₂ brine and thickening was effected at low speed at RT over a period of 20 min on a Hamilton Beach Mixer. Thereafter, in each case 3.15 g of Rewomid DC 212 and 0.35 g of Accosoft 808 were added to the thickened gels and homogenized in the gel for 5 min on the magnetic stirrer in a beaker. Thereafter, in each case 35 g of rapeseed oil were added to the two batches and stirred again for 5 min with a magnetic stirrer, a stable and well thickened o/w emulsion having formed. The beakers with the polymer gel were heated to 55° C. and the rheology was measured using a FANN 35SA rotational viscometer. Thereafter, in each case 100 ml of crude oil were added and stirred with heating to 55° C. for about 10 min on the magnetic stirrer before a FANN 35SA measurement was carried out again. The addition of 100 ml of crude oil and the measurement of the rheology at 55° C. were repeated 4 or 5 times, 200 or 250 ml of crude oil altogether then having been added.

A) 9.5 ppg of NaCl solution (density = 1.14 g/ml)
Oil for standardization: rapeseed oil

| | Description (all | FANN Readings | | |
|---|---|---|---|---|
| Test No. | measurements at 55° C.) | 600-300-200-100-6-3 | PV | YP |
| 1 | after addition of 35 g of | 59-46-40-32-15-12 | 13 | 33 |
| | rapeseed oil | | | |
| 2 | further addition of crude | 38-27-22-16-6-6 | 11 | 19 |
| | oil: | | | |
| | plus 100 ml | | | |
| 3 | plus 100 ml | 38-27-22-16-6-5 | 11 | 16 |
| 4 | plus 100 ml | 46-36-31-22-5-3 | 10 | 26 |
| 5 | plus 100 ml | 61-43-35-24-5-3 | 18 | 25 |
| 6 | plus 100 ml | 54-41-36-24-5-3 | 13 | 28 |

Explanation: the viscosity at low shear rates (6 and 3 readings) decrease significantly after addition of the crude oil and remain at a low level even on addition of an excess of crude oil. The increase in the yield point (YP) is moderate on addition of oil and does not reach the level of the starting system.

B) 10.0 ppg of CaCl₂ solution (density = 1.20 g/ml)
Oil for standardization: maize oil

| | Description (all | FANN Readings | | |
|---|---|---|---|---|
| Test No. | measurements at 55° C.) | 600-300-200-100-6-3 | PV | YP |
| 1 | after addition of 35 g of | 79-62-53-41-17-14 | 17 | 45 |
| | maize oil | | | |
| 2 | further addition of crude | 67-50-43-33-12-10 | 17 | 33 |
| | oil: | | | |
| | plus 100 ml | | | |
| 3 | plus 100 ml | 50-35-29-21-7-5 | 15 | 20 |
| 4 | plus 100 ml | 51-36-30-21-5-3 | 15 | 21 |
| 5 | plus 100 ml | 52-36-32-22-4-2 | 16 | 20 |

Explanation: the viscosity at low shear rates (6 and 3 readings) decrease significantly after addition of the crude oil and remain at a low level even on addition of an excess of crude oil. The yield point (YP) decreases on addition of oil and levels off at a low level.

1-14. (canceled)

15. A method comprising breaking the viscosity of an aqueous phase thickened with polymer in the exploration, stimulation or production of mineral oil or natural gas by forming a low-viscosity emulsion having water as the continuous phase by adding of at least one surface-active component a) to a system which comprises the aqueous phase thickened with a polymer component and an oil phase which is crude oil present in the reservoir or that is an oil introduced into the reservoir.

16. A method according to claim 15, wherein the surface-active component a) is added to at least one of the thickened aqueous phase or to the oil phase.

17. A method according to claim 15, wherein the introduced oil component is at least one selected from diesel oil, mineral oil, ester oil, a natural oil, a natural fat, a saturated synthetic oil, a unsaturated synthetic oil or a chemical modification or a mixture thereof.

18. A method according to claim 15, wherein the component a) is a surfactant selected from the group consisting of a non-ionic surfactant, a cationic surfactant and an amphoteric surfactant.

19. A method according to claim 18, wherein the non-ionic surfactant is selected from the group consisting of an ethoxylated straight-chain alcohol, an ethoxylated branched alcohol, an ethoxylated carboxylic acid, and an ethoxylated ester of glycerol.

20. A method according to claim 18, wherein the non-ionic surfactant is an ethoxylated nonylphenol having 2 to 11 EO units, a C₉-C₁₄-alcohol having 2 to 8 EO units, a ethoxylated tridecanol having 2 to 4 EO units, or a carboxylic acid having 9 to 14 carbon atom and 2 to 8 EO units.

21. A method according to claim 18, wherein the surfactant is an ethoxylated amine, a C₈-C₁₈-alkanolamide or imidazoline, an amine having 8 to 16 carbon atoms and 2 to 8 EO units, cocodiethanolaminoamide, or a betaine.

22. A method according to claim 21, wherein the betaine is an amidopropyl betaine having 8 to 14 carbon atoms.

23. A method according to claim 15, wherein a component b) selected from the group consisting of a demulsifier, a non-emulsifier, a co-surfactant and a surface tension modifier, which prevent the formation of a high-viscosity emulsion, is used with the component a).

24. A method according to claim 23, wherein the component b) is 2-ethylhexanol or imidazoline quats, a demulsifying polymer,

25. A method according to claim 24, where the component b) is a methyl-1-tallow amidoethyl-2-tallow-imidazolinium methosulphate co- and terpolymers of methacrylic acid, (partly) ethoxylated abietylamine or a polyether-modified polysiloxane.

26. A method according to claim 23, wherein component b) is a silicone derivative or polymer having (per)fluorinated carbon side chain.

27. A method according to claim 23, wherein component b) is a silicone oil.

28. The method of claim 23, wherein component b) is a dimethylpolysiloxane or an α, co-difunctional silicone quat.

29. A method according to claim 23, wherein component b) is a co-surfactant that is a alkylpolyglucoside (APG).

30. A method according to claim 23, wherein the component a) and optionally the component b) are present in an amount between 0.05 and 5.0% by weight based on the amount of the water phase, oil phase or both the water and oil phases.

31. A method according to claim 15, wherein an o/w emulsion forms, and a mixed emulsion system forms at the time of breaking of the viscosity.

32. A method according to claim 15, wherein the component a) and optionally component b) are provided as a preformulation which is a suspension in combination with a polymer component which is suitable for thickening the water phase.

33. A method according to claim 15, wherein a thickened aqueous phase formed is a drilling fluid that is a fracturing fluid, a drill-in fluid, an acidizing fluid, a completion brine or a fluid-loss pill.

34. A method according to claim 15, wherein the method is conducted in an area of oil-carrying ground layer.
